(19) United States
(12) Patent Application Publication
(10) Pub. No.: US 2008/0160290 A1
(43) Pub. Date: Jul. 3, 2008

(54) ALIGNED NANOPARTICLE CHANNEL AND METHOD OF FABRICATING ALIGNED NANOPARTICLE CHANNEL BY APPLYING SHEAR FORCE TO IMMISCIBLE BINARY POLYMER-BLENDED NANOPARTICLE COMPOSITE

(75) Inventors: Su Dong Park, Changwon-city (KR); Dong Hee Han, Changwon-city (KR); Young Hwan Kwon, Gyeongsan-city (KR)

Correspondence Address: Hyun Jong Park;TUCHMAN & PARK LLC, 41 White Birch Road, Redding, CT, 06896-2209, US

(73) Assignee: Korea Electrotechnology Research Institute, Changwon-si (KR)

(21) Appl. No.: 11/846,452

(22) Filed: Aug. 28, 2007

(30) Foreign Application Priority Data
Aug. 30, 2006 (KR) 10-2006-0082706
Jun. 29, 2007 (KR) 10-2007-0065144

(51) Int. Cl. C08K 3/04; B32B 5/16; B01F 17/00; C08K 3/08

(52) U.S. Cl. 428/327; 524/495; 524/1; 524/528; 524/440

(57) ABSTRACT

A method of fabricating an aligned nanoparticle channel, including a first step of forming a polymer nanoparticle blended composite by dispersing nanoparticles in a first polymer; a second step of forming a binary polymer nanoparticle blended composite by melt-blending the polymer nanoparticle blended composite with a second polymer, which is immiscible with the first polymer, and then cooling the mixture; and a third step of forming an aligned nanoparticle channel by applying a shear force to the binary polymer nanoparticle blended composite such that the nanoparticles dispersed in the first polymer are aligned in a direction parallel to the shear force, and an aligned nanoparticle channel fabricated using the method.

### FIELD OF THE INVENTION

The present invention relates to an aligned nanoparticle channel in which nanoparticles are aligned in a predetermined direction, and, more particularly, to a method of fabricating an aligned nanoparticle channel by applying a shear force to an immiscible binary polymer-blended nanoparticle composite, in which a shear force is applied to a composite of nanoparticles and immiscible polymers, and thus the nanoparticles are aligned in a direction parallel to the shear force in a state in which they are dispersed only in a specific polymer, and to an aligned nanoparticle channel fabricated using the method.

### BACKGROUND OF THE INVENTION

Generally, a nanoparticle is a particle having a size of about several tens to several hundreds of nm. The components of a nanoparticle may include various kinds of metals, nonmetals, semiconductors, magnetic materials, and the like. Particularly, in the present invention, as the nanoparticle, a carbon nanotube, having metallic properties, semiconductive properties, and, if necessary, nonmetallic properties, will be described.

The carbon nanotube has an electrical resistance of 10⁻⁴ Ωcm, and thus has electroconductivity next to that of a metal. Moreover, the carbon nanotube has 1000 times or more of the surface area of a bulk material. Therefore, recently, research on the carbon nanotube has been actively conducted in the field of the production and application thereof. In particular, since the carbon nanotube has electroconductivity in metals and semiconductivity in semiconductors depending on the shape and size thereof, and is chemically and mechanically stable, it is expected that the carbon nanotube will be variously used in the fields of electronic circuits, super strength fibers and surface materials.

Further, since the carbon nanotube has anisotropy, which means that it exhibits different properties in a longitudinal direction and a radial direction, depending on the shape and structure thereof, it is expected that the carbon nanotube will be variously used in application fields requiring such anisotropy.

However, the carbon nanotube has a problem in that, since the carbon nanotube has a diameter of several nanometers and a length of 1000 times or more of the diameter and becomes randomly tangled in the case where it is fabricated using a general electric discharge method, the anisotropy of the carbon nanotube cannot be properly used in fields of application thereof.

In order to solve this problem, methods for uniformly dispersing the carbon nanotubes and aligning them in a predetermined direction are keenly required, and research on these methods is being actively conducted.

As conventional technologies, Korean Patent Application No. 10-2001-0034391 discloses “a uniaxially aligned carbon nanotube micro string and a fabricating method thereof”, in which carbon nanotubes are dispersed in a polymer solution, and the polymer solution having the carbon nanotubes dispersed therein is passed through a capillary tube, and thus the carbon nanotubes are aligned in the direction in which the solution flows, and then the polymer solution, having passed through the capillary tube, is solidified using ethanol, thereby fabricating a carbon nanotube micro string; Korean Patent Application No. 10-2003-0095837 discloses “a carbon nanotube having magnetic property and a packing and manufacturing method thereof”, in which carbon nanotubes are substantially perpendicularly aligned by growing carbon nanotubes with seeds using an arc discharge method and then magnetizing the carbon nanotubes; Korean Patent Application No. 10-2002-7011025 discloses “a method for obtaining macroscopic fibers and strips from colloidal particles and, in particular, carbon nanotubes”, in which the particles are agglomerated into fibers or strips by injecting carbon nanotubes, dispersed in a surfactant, through an orifice, thus aligning the particles; Korean Patent Application No. 10-2004-0107519 discloses “a method of preparing a composite and aggregate including carbon nanotubes”, in which the carbon nanotube composite is prepared by electro-spinning a carbon nanotube solution dispersed in a polymer solution, thus forming a nanofiber web, and then melting and combining the nanofiber web; and Korean Patent Application No. 10-2003-0018056 discloses “a nano-composite fiber and its preparation method and use”, in which carbon nanotubes are dispersed in a polymer solution, and a high-voltage electric field is applied to the polymer solution dispersed with the carbon nanotubes, thereby forming a nano-composite fiber web.

It can be seen that the above conventional technologies are a technology for forming micro strings and webs aligned in a specific direction by injecting a carbon nanotube dispersed solution into a electromagnetic field or applying an electromagnetic field to a carbon nanotube dispersed solution, or for forming micro strings and webs aligned in a constant direction (in the direction in which the solution flows) by injecting a carbon nanotube dispersed solution through a capillary, orifice, etc.

However, these conventional methods for aligning carbon nanotubes have problems in that most carbon nanotubes are formed into thin sheets or micro strings, and thus the use thereof is limited, and carbon nanotubes are not properly aligned depending on the laboratory conditions because they are sensitive to temperature and humidity, and it is difficult to control the methods.

Meanwhile, the purpose of aligning carbon nanotubes in a predetermined direction is to obtain high-strength carbon nanotube fibers for industrial use. However, there is a problem in that the carbon nanotubes prepared using these conventional methods cannot maintain the alignment thereof for a long time, and thus the strength thereof becomes low, so that the application field thereof is limited, and the anisotropy thereof cannot be properly taken advantage of.

Therefore, in order to variously use the characteristics of various nanoparticles including the carbon nanotubes, research for uniformly dispersing the nanoparticles and stably aligning the nanoparticles in a predetermined direction is required.

### SUMMARY OF THE INVENTION

Accordingly, the present invention has been made keeping in mind the above problems occurring in the prior art, and an object of the present invention is to provide a method of fabricating an aligned nanoparticle channel by applying a shear force to an immiscible binary polymer-blended nanoparticle composite, in which a shear force is applied to a composite of nanoparticles and immiscible polymers, and thus the nanoparticles are aligned in a direction parallel to the shear force in a state in which they are dispersed only in a specific polymer, and the aligned nanoparticle channel fabricated using the method.

In order to accomplish the above object, the present invention provides a method of fabricating an aligned nanoparticle channel, including a first step of forming a polymer nanoparticle blended composite by dispersing nanoparticles in a first polymer; a second step of forming a binary polymer nanoparticle blended composite by melt-blending the polymer nanoparticle blended composite with a second polymer, which is immiscible with the first polymer, and then cooling the mixture; and a third step of forming an aligned nanoparticle channel by applying a shear force to the binary polymer nanoparticle blended composite such that the nanoparticles dispersed in the first polymer are aligned in a direction parallel to the shear force, and provides an aligned nanoparticle channel fabricated using the method.

The first step may include preparing a dispersion solution by dissolving the first polymer in a nonsolventable solvent, adding a dispersant to the solution and then stirring the solution to which the dispersant is added; and adding nanoparticles to the dispersion solution and then ultrasonically dispersing the dispersion solution to which the nanoparticles have been added.

In the third step, it is preferred that the shear force be applied to the binary polymer nanoparticle blended composite at a temperature at which the viscosity ratio of the first polymer to the second polymer is in a range of 0.5˜1.5.

It is preferred that the first polymer be formed of polystyrene, and that the second polymer be formed of low density polyethylene.

It is preferred that the nanoparticle be one selected from among a carbon nanotube, copper, nano-carbon black, gold, silver, platinum, and a mixture thereof.

Accordingly, the aligned nanoparticle channel of the present invention is advantageous in that, since the aligned nanoparticle channel is configured such that nanoparticles are aligned in a direction parallel to a shear force in a state in which they are dispersed only in a specific polymer by applying the shear force to a composite of the nanoparticles and immiscible polymers, the electroconductivity and anisotropy thereof are improved, and thus the aligned nanoparticle channel can be used as an excellent material in the application field using the properties thereof; since the nanoparticles are dispersed in a specific polymer and are not dispersed in other polymers, the aligned nanoparticle channel, aligned in a predetermined direction, can stably and continuously maintain the aligned state, and thus is stably used in industrial fields; and, since the aligned nanoparticle channel, aligned in a specific direction regardless of the thickness and size thereof, can be obtained, the aligned nanoparticle channel can be variously used in the application field thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a first process of fabricating an aligned carbon nanotube channel according to the present invention;

FIG. 2 is a schematic view showing a second process of fabricating an aligned carbon nanotube channel according to the present invention;

FIG. 3 is a schematic view showing a third process of fabricating an aligned carbon nanotube channel according to the present invention;

FIG. 4 is a scanning electron microscope (SEM) photograph showing an aligned carbon nanotube channel observed from a direction parallel to a shear force according to the present invention; and

FIG. 5 is a scanning electron microscope (SEM) photograph showing an aligned carbon nanotube channel observed from a direction perpendicular to a shear force according to the present invention.

### DETAILED DESCRIPTION OF THE INVENTION

Hereinafter, preferred embodiments of the present invention will be described in detail with reference to the attached drawings.

In the aligned nanoparticle channel of the present invention, a nanoparticle is a particle having a diameter of several tens to several hundreds of nm. The nanoparticle is not limited as long as it exhibits material properties, such as electroconductivity, thermal conductivity, resistance, and the like, when it is aligned in a predetermined direction. The components of the nanoparticle may include any kind of metal, nonmetal, semiconductor, magnetic material, and the like.

Particularly, the present invention will be described based on a carbon nanotube having excellent material properties which can be applied in industrial fields after the carbon nanotube is fabricated into an aligned channel. Generally, the carbon nanotube exhibits anisotropy, and has metallic properties, semiconductive properties, and, if necessary, nonmetallic properties.

The present invention provides an aligned nanoparticle channel fabricated by applying a shear force to an immiscible binary polymer-blended nanoparticle composite, in which a shear force is applied to a composite of nanoparticles and immiscible polymers and thus the nanoparticles are aligned in a direction parallel to the shear force in a state in which they are dispersed only in a specific polymer.

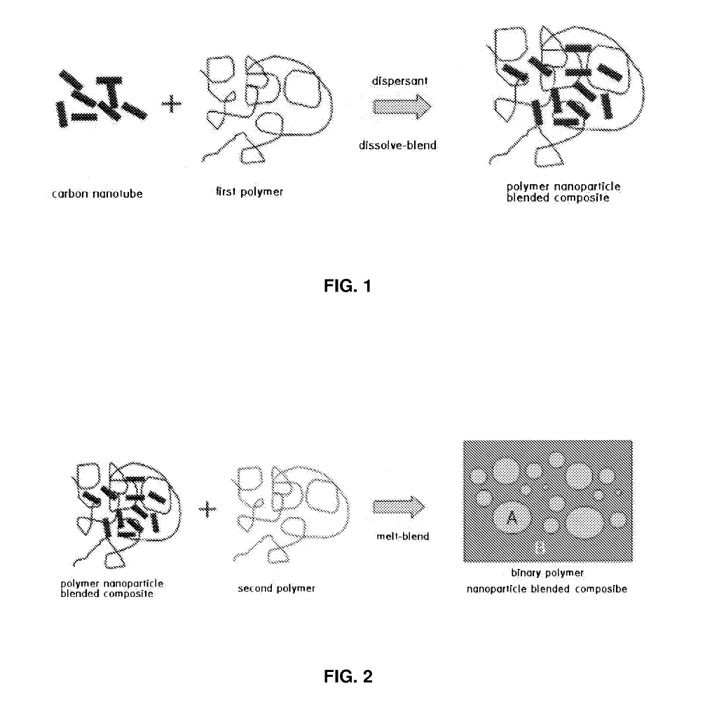

First, as shown in FIG. 1, in the first step, a polymer-blended carbon nanotube composite is formed by dispersing carbon nanotubes in a first polymer. Here, the carbon nanotube may be suitably selected from among a single-walled carbon nanotube, a double-walled carbon nanotube, a multi-walled carbon nanotube, and the like, according to the use thereof.

In order to uniformly disperse the carbon nanotube in the first polymer, after a dispersion solution is prepared by dissolving the first polymer in a nonsolventable solvent, adding a dispersant thereto and then stirring it, the carbon nanotubes are dispersed by adding them to the dispersion solution and then applying ultrasonic waves thereto for a predetermined time. Subsequently, the solvent is removed therefrom using reduced-pressure distillation, thereby obtaining a polymer-blended carbon nanotube composite in which the carbon nanotubes are uniformly dispersed in a solid-state first polymer.

Further, as shown in FIG. 2, in the second step, the polymer-blended carbon nanotube composite is melt-blended with a second polymer, immiscible with the first polymer, at a predetermined temperature, thus obtaining a material in which the polymer-blended carbon nanotube composite and the second polymer are melted. Subsequently, the obtained material is cooled, thereby preparing a solid-state binary polymer-blended carbon nanotube composite. Here, the first polymer and second polymer may be suitably selected from among mutually immiscible polymers, according to the use thereof.

In this case, in the binary polymer-blended carbon nanotube composite, since the first polymer and second polymer are mutually immiscible and thus remain in separate phases from each other, the binary polymer-blended carbon nanotube composite, like water and oil, is spherically formed in a state in which carbon nanotubes are uniformly dispersed therein, and the second polymer has a continuous phase. That is, the carbon nanotubes are selectively dispersed only in the first polymer.

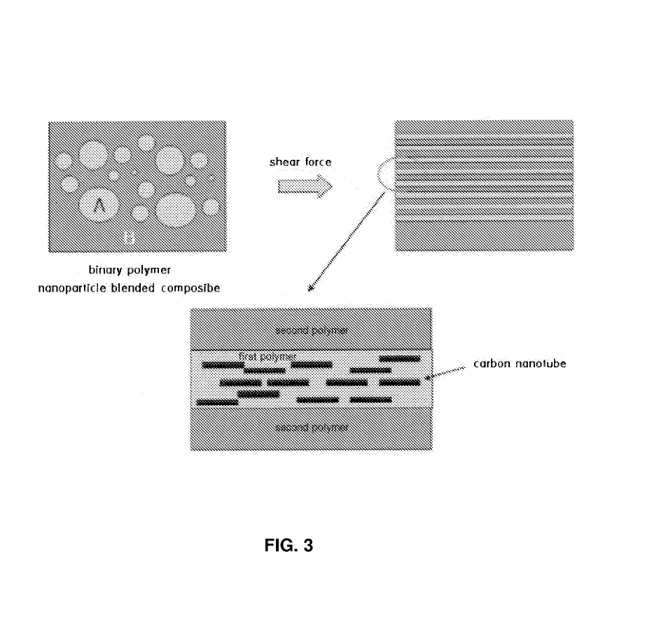

Further, as shown in FIG. 3, in the third step, a shear force is applied to the binary polymer-blended carbon nanotube composite, thereby forming an aligned carbon nanotube channel in which the carbon nanotubes are selectively dispersed in only the first polymer and are aligned in a direction parallel to the shear force.

The shear force is continuously applied to the binary polymer-blended carbon nanotube composite at a predetermined temperature for a predetermined amount of time using a rheometer or a roll mill. As described above, since the first polymer and second polymer are mutually immiscible and thus remain in separate phases from each other, when the shear force is applied to the binary polymer-blended carbon nanotube composite at this time, the first polymer and second polymer are respectively elongated in a specific condition, preferably at a temperature at which the viscosity ratio of first polymer to second polymer is in a range of 0.5˜1.5, and more preferably at a temperature at which the viscosity ratio thereof is equal, and thus the carbon nanotubes dispersed in the first polymer are aligned in the direction in which the first polymer is elongated. That is, the carbon nanotubes are selectively dispersed and aligned only in the first polymer.

As described above, the carbon nanotubes are selectively dispersed only in the first polymer, and are aligned in the direction in which the first polymer is elongated, or in a direction parallel to the shear force, and the second polymer is placed around the first polymer, so that the carbon nanotubes are aligned in a constant direction in a state in which they are entirely uniformly dispersed. Subsequently, the carbon nanotubes dispersed and aligned in the first polymer are cooled, thereby obtaining an aligned carbon nanotube channel.

In addition, in this case, various aligned carbon nanotube channels having various sizes and thicknesses can be obtained by adjusting the amounts of the carbon nanotubes, first polymer, and second polymer. Further, an aligned carbon nanotube film can be obtained by applying the carbon nanotube channel on the upper surface of a substrate. Moreover, a bulk-state carbon nanotube aligned structure can be obtained.

Hereinafter, a preferred example of the present invention will be described in detail.

A multi-walled carbon nanotube was used as the carbon nanotube, polystyrene was used as the first polymer, and low density polyethylene (LDPE) was used as the second polymer. Further, dichloroethylene (DCE) was used as the nonsolvent solvent, and KD-15 was used as the dispersant.

First, 5 g of polystyrene was completely dissolved in 100 ml of dichloroethylene, 1 g of KD-15 was added thereto to form a mixed solution, and then the mixed solution was stirred for about 1 hour, thereby obtaining a dispersion solution. Subsequently, 1 part by weight of carbon nanotubes, based on 100 parts by weight of the polystyrene, was added to the dispersion solution, and then the dispersion solution, to which carbon nanotubes were added, was dispersed for 5 hours using ultrasonic waves. Subsequently, the dichloroethylene, which is a solvent, was removed from the dispersion solution through reduced-pressure distillation, thereby obtaining a solid polystyrene-blended carbon nanotube composite in which the carbon nanotubes are uniformly dispersed in the polystyrene.

Subsequently, 15% by weight of the polystyrene-blended carbon nanotube composite was mixed with 85% by weight of low density polyethylene, and then the mixture was melt-blended at a temperature of about 200° C., thereby obtaining a low density polyethylene and polystyrene blended carbon nanotube composite, which is a binary polymer blended carbon nanotube composite.

Subsequently, a shear force was continuously applied to the low density polyethylene and polystyrene blended carbon nanotube composite at a temperature of 200° C., at which the viscosity ratio of the low density polyethylene to the polystyrene is about 1, for 2 hours using a rheometer at a shear rate of 10 s⁻¹. After 2 hours passed, the low density polyethylene and polystyrene blended carbon nanotube composite was rapidly cooled with liquid nitrogen, and was thus recovered from the rheometer.

Accordingly, an aligned carbon nanotube channel which is uniformly and stably aligned in a predetermined direction could be obtained through these processes.

In order to evaluate the morphology of the obtained aligned carbon nanotube channel, a sample of the aligned carbon nanotube channel cut in a direction parallel to the shear force and a sample thereof cut in a direction perpendicular to the shear force were analyzed using a scanning electron microscope (SEM). Before these samples were analyzed using the SEM, the samples were sufficiently cooled with liquid nitrogen, the samples were cut using a doctor's blade method, polystyrene carbon nanotube regions were extracted from the cut samples using toluene in order to improve the contrast of the SEM, and then the cut samples were dried.

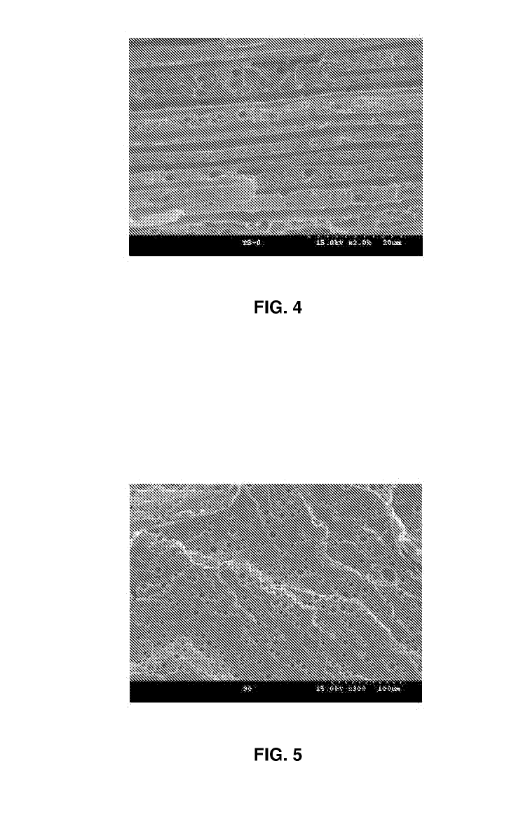

The SEM analysis photographs of the aligned carbon nanotube channels through the above processes are shown in FIGS. 4 and 5. As is apparent from FIG. 4, it was found that the polystyrene and low density polyethylene were in separate phases from each other, and it was found that, since the two materials are immiscible, the carbon nanotubes were uniformly dispersed only in the polystyrene, and are thus aligned in a specific direction therein. FIG. 5 is a scanning electron microscope (SEM) photograph showing a sample cut in a direction perpendicular to a shear force. As is apparent from FIG. 5, it was found that the spherical part of FIG. 5 is polystyrene in which the carbon nanotubes are dispersed, and the linear part thereof is low density polyethylene.

The aligned nanoparticle channel according to the present invention is effective in that, since the aligned nanoparticle channel is configured such that nanoparticles are aligned in a direction parallel to a shear force in a state in which they are dispersed only in a specific polymer by applying the shear force to a composite of the nanoparticles and immiscible polymers, the electroconductivity and anisotropy thereof are improved, and thus the aligned nanoparticle channel can be used as an excellent material in the application field that requires the properties thereof.

Further, the aligned nanoparticle channel according to the present invention is effective in that, since the nanoparticles are dispersed in a specific polymer and are not dispersed in other polymers, the aligned nanoparticle channel, aligned in a predetermined direction, can stably and continuously maintain the aligned state, and thus is stably used in industrial fields.

Further, according to the present invention, it is expected that, since the aligned nanoparticle channel, stably aligned in a specific direction, can be obtained by applying a shear force thereto after dispersion and blending processes, the fabrication method and control thereof is easy, and, since the aligned nanoparticle channel, aligned in a specific direction regardless of the thickness and size thereof, can be obtained, the aligned nanoparticle channel can be variously used in the application field thereof.

Moreover, the present invention is effective in that any material can be used as the nanoparticle, as long as it is a material which can be aligned in a specific direction, and particularly, the anisotropy of the carbon nanotube can be fully taken advantage of because an aligned channel stable to the carbon nanotube can be obtained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of fabricating an aligned nanoparticle channel, comprising the steps of:
forming a polymer nanoparticle blended composite by dispersing nanoparticles in a first polymer;
forming a binary polymer nanoparticle blended composite by melt-blending the polymer nanoparticle blended composite with a second polymer, which is immiscible with the first polymer, and then cooling the mixture; and
forming an aligned nanoparticle channel by applying a shear force to the binary polymer nanoparticle blended composite such that the nanoparticles dispersed in the first polymer are aligned in a direction parallel to the shear force.

2. The method according to claim 1, wherein the step of forming the polymer nanoparticle blended composite comprises:
preparing a dispersion solution by dissolving the first polymer in a nonsolventable solvent, adding a dispersant to the solution and then stirring the solution to which the dispersant is added; and
adding nanoparticles to the dispersion solution and then ultrasonically dispersing the dispersion solution to which the nanoparticles are added.

3. The method according to claim 1, wherein, in the step of forming the aligned nanoparticle channel, the shear force is applied to the binary polymer nanoparticle blended composite at a temperature at which the viscosity ratio of the first polymer to the second polymer is in a range of 0.5˜1.5.

4. The method according to claim 3, wherein the first polymer is formed of polystyrene, and the second polymer is formed of low density polyethylene.

5. The method according to claim 1, wherein the nanoparticle is one selected from among a carbon nanotube, copper, nano-carbon black, gold, silver, platinum, and a mixture thereof.

6. An aligned nanoparticle channel fabricated using the method according to claim 1.

7. An aligned nanoparticle channel fabricated using the method according to claim 5.
